(19) United States
(12) Patent Application Publication
(10) Pub. No.: US 2013/0220941 A1
(43) Pub. Date: Aug. 29, 2013

(54) METHOD FOR PURIFYING WATER

(71) Applicants: Teuvo Kekko, Helsinki (FI); Pekka Lönnqvist, Helsinki (FI); Pasi Makkonen, Helsinki (FI); Jyri Maunuksela, Helsinki (FI)

(72) Inventors: Teuvo Kekko, Helsinki (FI); Pekka Lönnqvist, Helsinki (FI); Pasi Makkonen, Helsinki (FI); Jyri Maunuksela, Helsinki (FI)

(21) Appl. No.: 13/819,138

(22) PCT Filed: Aug. 26, 2011
(86) PCT No.: PCT/FI2011/050746

§ 371 Date: May 7, 2013

(30) Foreign Application Priority Data
Aug. 31, 2010 (FI) 20105919

(51) Int. Cl. C02F 1/68

(52) U.S. Cl. CPC C02F 1/68
USPC 210/748.1; 210/749; 210/754; 210/96.1

(57) ABSTRACT

A method and a system for continuous purification of wastewater and/or utility water, wherein peracetic acid is metered into the wastewater, the flow of the wastewater, redox potential and the concentration of peracetic acid are measured, and the metering of peracetic acid is adjusted relative to the variation in the flow and on the basis of the concentration of peracetic acid and redox potential.

### FIELD OF THE INVENTION

The invention relates to methods for purifying wastewater and utility water and to a water purification system.

### BACKGROUND OF THE INVENTION

Water is becoming a more and more important matter around the world. While the resources of clean water are reduced, the use of water is increasing and natural waters are becoming more and more polluted. Thus, a growing need has developed for new effective and economical ways of purifying wastewater and raw water. There also exists a need to reduce the use of chlorine and its derivatives in the purification of household water and wastewater for the reason that they form carcinogenic compounds.

The current water treatment chemicals and methods encompass several problems.

Chlorine and chlorine compounds may form toxic compounds, taste and odor compounds and cause bio-corrosion. Furthermore, chlorine and chlorine compounds may also form halogenated organic compounds that are carcinogenic.

Ozone is an expensive and toxic gas which participates in the formation of toxic compounds from the humus, and the manufacture of which is energy intensive.

Sulfate-based precipitation chemicals increase the sulfur load and form toxic hydrogen sulfide by the effect of microbial activity in oxygen-free spaces. Polymer-based precipitation chemicals disintegrate slowly, may transfer heavy metals, have a meager effect and do not affect the microbiology or the odors.

Potassium permanganate that is used in the precipitation of iron and manganese is toxic, expensive and staining.

UV is an energy intensive way of purification. In addition, microbes recover from the UV-treatment, UV does not provide much of a possibility for adjustment; it is either on or off. UV bulbs contain mercury that stresses the nature.

The problem with sand filtration is blockage of the filters and the cost. In addition, sand filtration does not eliminate all of the microbes.

The problem with application of lime is the blockage of pipes and protection for biofilms.

Activated carbon becomes blocked if not maintained on a regular basis. The regeneration of activated carbon is often expensive.

An aerobic aeration basin produces carbon dioxide and is energy intensive and produces plenty of biosludge.

The anaerobic process is expensive and requires a thick starting product. The anaerobic process produces unhygienic sludge and smelly reject water.

Nitrogen removal reduces the fertilizer value and requires supporting chemicals and causes bulking sludge.

Odor elimination by nitrates brings nutrients and odors may increase at a later stage.

Odor elimination by sulfates stains the water and brings sulfur to the process that may form hydrogen sulfide at a later stage.

Biological membranes are expensive and become blocked, and booster pumps are often needed in connection with them, which increases the costs and energy consumption (e.g. in reverse osmosis, nano-, micro- and ultrafiltration).

The use of peracetic acid encompasses the risk of over- or undermetering. The costs and the carbon footprint are increased by using too much of the chemical. Peracetic acid is toxic in high concentrations, whereas undermetering leads to hygiene risks. The use of peracetic acid has not generalized, despite several publications addressing the purifying effects of peracetic acid, because the metering of peracetic acid is difficult and it is relatively expensive.

None of the generally used methods properly removes the hormones, algaecides, residual antibiotics, heavy metals and other environmental toxins.

The use of peracetic acid in the purification of utility water is known for example from publication WO 2009/130397. Publication US 2004/0154965 discloses the use of peracetic acid for disinfection of floodwaters.

### OBJECTIVE OF THE INVENTION

The objective of the invention is to disclose a new type of an effective method for continuous purification of wastewater and utility water. One specific objective of the invention is to alleviate the problems referred to above.

The objective of the invention is to disclose a new and cost-effective method for metering peracetic acid into waste- and/or raw water to be purified so as to achieve an optimal disinfection result with a small amount of peracetic acid.

In other words, the objective of the invention is to disclose a method wherein peracetic acid can be used cost-effectively to disinfect water so as to be able to minimize and/or normalize the residual amount of peracetic acid in the water. Yet doing this in a way that the disinfection by peracetic acid is sufficiently effective. One objective of the invention is to disclose a method wherein the addition of a halogen, such as chlorine, into utility water can be reduced and wherein the formation of carcinogens formed by chlorine can be effectively reduced.

### SUMMARY OF THE INVENTION

The method for purifying wastewater according to the invention is characterized by what has been presented in claim 1.

The method for purifying utility water according to the invention is characterized by what has been presented in claim 7.

The system for purifying water according to the invention is characterized by what has been presented in claim 13.

The invention is based on a research work conducted to enhance the continuous purification of water. In this connection, it was unexpectedly discovered that redox potential is extremely well suited to analyze the metering of peracetic acid in connection with the purification of water.

In the application, wastewater refers to sewage water or other such water that includes microbes and/or organic matter. Utility water refers herein to tap water or other such water that is meant for use by people and/or domestic animals or for use as irrigation water. Raw water refers to water that is used by water intake plants to produce utility water. Raw water can be drawn from groundwater, surface water or other water supply.

The continuous wastewater purification method according to the invention comprises measuring the flow of water, the residual peracetic acid in the water and the redox potential of the water, and on this basis adjusting the amount of peracetic acid to be metered so as to achieve the optimal disinfection result with a small amount of peracetic acid.

Peracetic acid effectively oxidizes bacteria coli in only a few minutes from the addition. The aqueous solution of peracetic acid also oxidizes many other bacteria and undesirable micro-organisms, such as the bacteria Salmonella and Legionella and the Giardia parasites, and promotes precipitation of heavy metals as well as iron and manganese by oxidation and pH effects.

In the method according to the invention, any strength of peracetic acid can be used. Preferably, the peracetic acid to be used is a 5 to 15 w-%, more preferably a 12 w-% peracetic acid solution.

The feed volume of peracetic acid into wastewater is 1 to 3 ppm of the amount of the outflowing water at a conventional water purification plant that purifies sewage water. Preferably, peracetic acid is added by 1.5 to 2 ppm. The amount of peracetic acid to be added may also be larger or smaller, depending on the purity of the water to be treated.

The method of the invention comprises measuring the flow of water. The flow is measured in connection with the metering of peracetic acid, close to the metering of peracetic acid in connection with the mixing of peracetic acid or downstream of the metering, for example in connection with measuring the concentration of peracetic acid. The flow is preferably measured in connection with the metering of peracetic acid. The metering of peracetic acid is adjusted relative to the variation in the flow, for example so as to double the amount of the metering of peracetic acid as the flow is doubled.

Peracetic acid is a strong oxidizer and is consumed as it oxidizes. Thus, peracetic acid is consumed over time. According to the invention, the residual concentration of peracetic acid is measured 4 to 10 minutes after the addition of peracetic acid. In a continuously flowing system, this means that the measurement is performed at a site that is at a flowing distance of approximately 4 to 10 minutes, on the average, downstream of the peracetic acid addition site. This is sufficient for mixing of the added peracetic acid with the water and reacting with undesirable micro-organisms. On the other hand, this time period is not too long, either, effectively to adjust the metering of peracetic acid. Preferably, the measurement is performed approximately 5 minutes after the addition of peracetic acid. The metering of peracetic acid is performed in such a way that a mixing as immediate as possible is achieved. The metering can be performed for example by spraying, injecting, draining, and it may be conducted at a site comprising a strong mixing flow such as when the water flows out from the primary sedimentation tank. The metering can be enhanced by mixing.

If the measurement was performed too soon after the addition of peracetic acid, too high a concentration would be obtained as a result because peracetic acid would not have had time completely to react but would continue reacting and oxidizing the micro-organisms and other objects. On the other hand, if the measurement was conducted too late, peracetic acid might already be disintegrated, which would result in too low a concentration as compared to that actually needed to disinfect the water. In addition, in a continuously flowing system, the further away the measurement site is located from the addition site, the longer becomes the delay in controlling the metering and the more inaccurately the metering can be adjusted. Such inaccuracy easily leads to a temporarily too high or too low a metering, in which case the quality of the water is momentarily compromised and, on the other hand, the metered amount and thereby the costs are increased.

In the method of the invention, the concentration of peracetic acid is maintained below 0.8 ppm, preferably below 0.5 ppm and most preferably at 0.05 to 2 ppm by adjusting the metering. If the concentration rises above a preset value, or clearly begins to rise, the metering is reduced and if the value clearly begins to fall, the metering is increased.

The method according to the invention comprises measuring the redox potential of water. Redox potential as a parameter of the metering of peracetic acid is a clear and functional analysis method. Redox potential strongly reacts to peracetic acid metering at small peracetic acid concentrations. The measurement can be performed immediately in connection with the metering of peracetic acid or close to the addition of peracetic acid in connection with the mixing of peracetic acid. The measurement can also be performed together with the measurement of the concentration of peracetic acid. Preferably, the measurement is performed immediately or close to the metering of peracetic acid.

According to the invention, the metering of peracetic acid is adjusted so as to have a redox potential of 50 to 250 mV, preferably 80 to 120 mV and more preferably of approximately 100 mV. If the redox potential rises above a preset value, the metering of peracetic acid is reduced, and if the potential falls below a preset value, the metering is increased.

Normally, the addition of peracetic acid heavily increases the redox potential. On the other hand, a strong decrease in the potential is indicative of the strength of microbial activity. Redox potential has been discovered to be a very sensitive meter to indicate such changes in the quality of water that affect the change in the need for peracetic acid. Thus, according to the invention, as the potential abruptly changes, the metering of peracetic acid is promptly changed.

According to one embodiment of the invention, the metering is controlled by a computer programmed using fuzzy logic so as to maintain the redox potential at 50 to 250 mV, preferably 80 to 120 mV and more preferably at approximately 100 mV, and the residual peracetic acid is maintained on the average below 0.8 ppm, preferably below 0.5 ppm and most preferably at 0.05 to 2. The programming of the computer can be carried out utilizing the conventional process control programs and methods.

According to one embodiment of the invention, the wastewater, such as sewage water, is possibly first allowed to precipitate in order to remove solid particles from the water. After this, the water is filtered, if desired, in order to remove smaller particles from the water. After this, peracetic acid is added and the water purified according to the invention. If necessary, the water may be filtered in order to remove precipitated micro-organisms, heavy metals and/or other impurities and directed to a discharge duct after filtration.

According to one preferred embodiment of the invention, the water is treated by UV light before directing it to the discharge duct. At this stage of the purification, the water is already quite clear, which promotes the penetration of UV light in the water and thereby enhances the effect thereof. On the other hand, peracetic acid disintegrates in UV light and thus even small traces thereof can be effectively eliminated from the water while the UV light disinfects from the water those microbes that have not been eliminated by the earlier purification steps.

By the above-described methods according to the invention, the wastewater can be purified with reasonable costs, and introduction of the partly harmful heavy metals and micro-organisms to water circulation and/or nature where they could pollute for example water intake plants, the nature or disturb recreational use is avoided in a controlled manner.

According to one embodiment of the invention, the wastewater that has been purified by the above-mentioned methods is directed to a water distribution system either directly or via a water purification plant. By the method according to the invention, it is possible to achieve a disinfection effect of such a degree that the wastewater that has been purified in this manner can directly or almost directly be used as raw water or utility water. Peracetic acid is not only effective in disintegrating microbes and microscopic organisms, but it also promotes the precipitation of iron and manganese from the water and disintegrates residual chemicals such as hormone and drug residues as well as hydrogen sulfide and bacteria that produce hydrogen sulfide.

The continuous utility water purification method according to the invention comprises metering peracetic acid to raw water, measuring the flow of raw water and the redox potential and measuring the concentration of peracetic acid downstream of the metering, and adjusting the metering of peracetic acid primarily directly according to the flow and secondarily so as to have a concentration of peracetic acid of less than 0.8 ppm and a redox potential of 50 to 250 mV.

According to one embodiment of the continuous utility water purification method, the metering of peracetic acid is secondarily adjusted so as to have a concentration of peracetic acid of less than 0.5 ppm and preferably of 0.05 to 0.2 ppm and a redox potential of 80 to 120 mV and preferably of approximately 100 mV.

According to one embodiment of the invention, the raw water, such as lake water or groundwater, is possibly first allowed to precipitate in order to remove solid particles from the water. After this, the water is filtered, if desired, in order to remove smaller particles from the water. If necessary, after purification of the raw water, the water can be filtered, if desired, in order to remove the precipitated micro-organisms and heavy metals.

According to one preferred embodiment of the invention, the water is treated by UV light before directing it to the water pipe. At this stage of the purification, the water is already quite clear, which promotes the penetration of UV light in the water and thereby enhances the effect thereof. On the other hand, peracetic acid disintegrates in UV light and thus even small traces thereof can be effectively eliminated from the water while UV light disinfects from the water those microbes that have not been eliminated by earlier purification steps.

According to one preferred embodiment of the invention, the water is chlorinated after the measurement of the concentration of peracetic acid and after the possible UV-treatment. According to this embodiment of the invention, the water to be chlorinated is nearly free of micro-organisms and organic matter in comparison with the conventional water purification plants. In this method according to the invention, the amount of chlorine can be considerably reduced, if desired, from the amount used in the conventional water purification plant. Preferably, the amount of chlorine is reduced by 70%, more preferably 30%, of the amount used in the conventional water purification plant. This method according to the invention enables the production of utility water with a considerably small amount of carcinogenic and other chlorine reaction compounds in comparison with the utility water produced by the conventional methods.

The addition of peracetic acid can be made at another site in the water purification system than those presented above, and the water purification system may include fewer or more purification steps than those presented above, or it may only include the peracetic acid treatment.

The system according to the invention for purifying water comprises
a peracetic acid metering device,
a flow meter for measuring the flow of water,
a sensor for measuring the redox potential,
an analyzer for measuring the concentration of peracetic acid and means for adjusting the metering device.

Any known meter suitable for measuring the flow of water can be used as the flow meter. Any known sensor suitable for measuring the redox potential such as a platinum or gold electrode can be used as the redox potential sensor. Any known meter suitable for measuring concentrations of less than 10 ppm can be used as the peracetic acid concentration analyzer.

The system according to the method according to the invention is a solution that is simple to install, inexpensive and light and can be easily installed in a water purification plant as either a continuously operating part or to be used in an emergency situation. The method according to the invention enhances the purification of wastewater, reduces odors and produces better quality water.

### LIST OF FIGURES

FIG. 1 illustrates a system for adjusting the method according to the invention.

FIG. 2 illustrates a system for adjusting a water purification plant of the method according to the invention.

FIG. 3 shows the discharge, the stroke rate of a PAA feed pump, the redox potential and the residual PAA in the method according to the invention.

### DETAILED DESCRIPTION OF THE INVENTION

### EXAMPLE 1

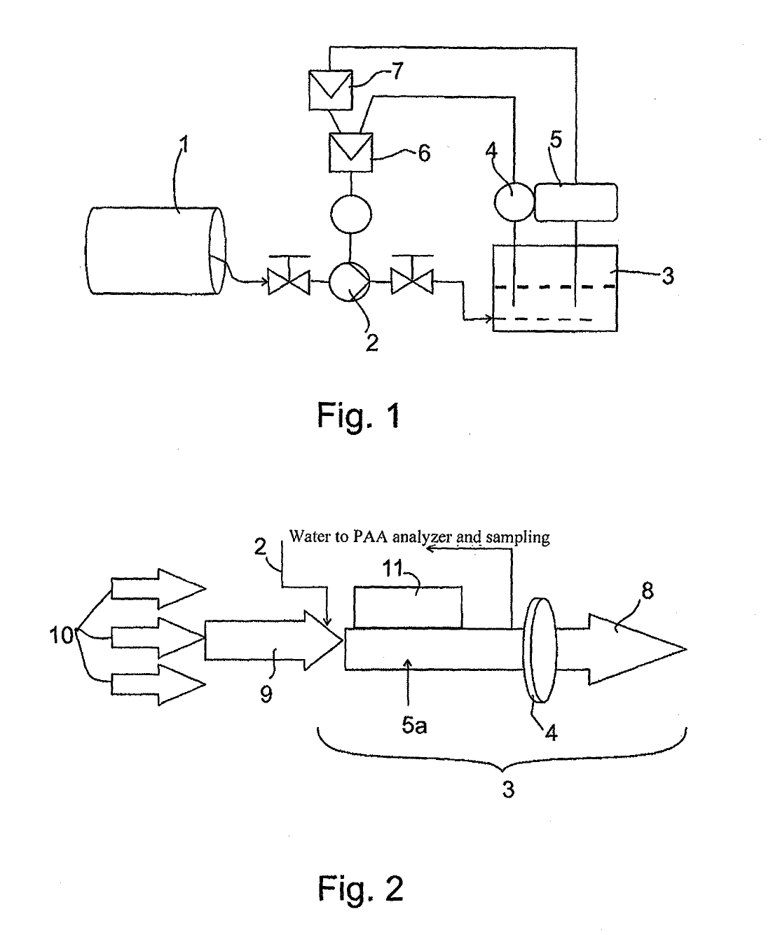

FIG. 1 illustrates an adjustment system according to one embodiment of the invention, comprising a peracetic acid metering vessel (1), a peracetic acid metering device (2) and a water purification system (3) into which peracetic acid is added.

The method according to FIG. 1 comprises measuring the flow (4) of the water purification system and the redox potential and peracetic acid concentration (5). The peracetic acid metering device (2) is adjusted according to the figure so as to adjust (7) the metering PI primarily relative to the variation of the flow. However, the metering device PV is also simultaneously adjusted (6) so as to have a redox potential of 50 to 250 mV and preferably 80 to 120 mV and most preferably of approximately 100 mV, and a residual amount of peracetic acid of less than 0.5 ppm and preferably of 0.05 to 0.2 ppm.

The measurements can be performed continuously or at specific intervals. According to one embodiment of the invention, the measurements are performed at intervals of one minute. The measurements can also be performed for example at intervals of one hour or at longer or shorter intervals.

According to one embodiment of the invention, the metering of peracetic acid is adjusted according to Table 1, where ‘Metering’ represents variation in the metering of peracetic acid, ‘Redox’ represents variation in the measured redox potential and ‘PAA’ represents variation in the concentration of peracetic acid. In addition, the metering can be adjusted according to the measured flow.

TABLE 1

| Metering | Redox | PAA |
|---|---|---|
| −− | ++ | ++ |
| − | + | ++ |
| − | − | ++ |
| 0 | −− | ++ |
| 0 | ++ | + |
| 0 | + | + |
| + | − | + |
| + | −− | + |
| 0 | ++ | 0 |
| 0 | + | 0 |
| + | − | 0 |
| ++ | −− | 0 |

Preferably, the method according to the invention is fine adjusted distinctly for each water purification plant in such a way that suitable numerical values are searched by experimenting for the values −, −−, +, ++, 0 presented in the table.

### EXAMPLE 2

The water purification system according to the invention was applied at a wastewater purification plant with three parallel purification lines operating by the same principle.

FIG. 2 illustrates the sites of the devices in the water purification system (3) at the wastewater purification plant. The adjustment system at the wastewater purification plant is installed in the water outflow duct (8). The water outflow duct (8) includes a flow meter (4), the signal of which is used for adjusting the system. The feed of the chemical is effected immediately after the collecting well (9) combining the three outflow lines of the plant. A redox sensor (5a) is installed downstream approximately five meters from the feed point. A control and monitoring system (11) and PAA (peracetic acid) analyzer are located in a sampling construction on top of the outflow duct in which the composite sampler of the waterworks is located. Water is raised by a pump from the water outflow duct approximately 50 meters down-stream of the feed point for the PAA analyzer and laboratory samples. The suction distance of the pump (50 m) in terms of time corresponds to the emptying of the outflow water in a lake. The control and management of the system are based on the flow signal of the plant, the PAA analyzer, the redox sensor as well as a remote management and monitoring apparatus.

During a 12 day reporting period, the out-flowing discharge from the wastewater purification plant, the stroke rate of the chemical feed pump, the redox potential and the residual PAA were measured. The measurements were conducted approximately at intervals of 5 minutes.

The PAA composition used contained 12 w-% of peracetic acid, 20 w-% of acetic acid and 20 w-% of hydrogen peroxide.

During the report period, the peracetic acid feed was on starting from day 1. The feeding of peracetic acid was started with approximately 1.6 ppm of peracetic acid in the outflow water. Five samples were taken, the first one being a 0-sample taken 3 days (day −3) before the chemical feed. The samples were taken from water flowing out into a lake. The following analyses were conducted for the samples:
Escherichia coli
Heat-resistant coliform bacteria/Intestinal enterococci or both
Biological oxygen demand 7 days, ATU addition
Chemical oxygen demand, COD Cr

The analysis results are presented in Table 2.

TABLE 2

| | | Heat- | | | |
|---|---|---|---|---|---|
| | | resistant | | | |
| | | coliform | Intestinal | | |
| | E. coli | bacteria | enterococci | | COD |
| Day | MPN/100 ml | CFU/100 ml | CFU/100 ml | BOD7ATU | mg/l |
| −3 | 11000 | | 3600 | <3 | 32 |
| 2 | <1 | <1 | 45 | 3.9 | 34 |
| | *CFU/100 ml | | | | |
| 6 | 3 | | 2 | 4.9 | 44 |
| 7 | 2 | | 4 | 6.1 | 45 |
| 8 | 3 | | 1 | 8.6 | 42 |

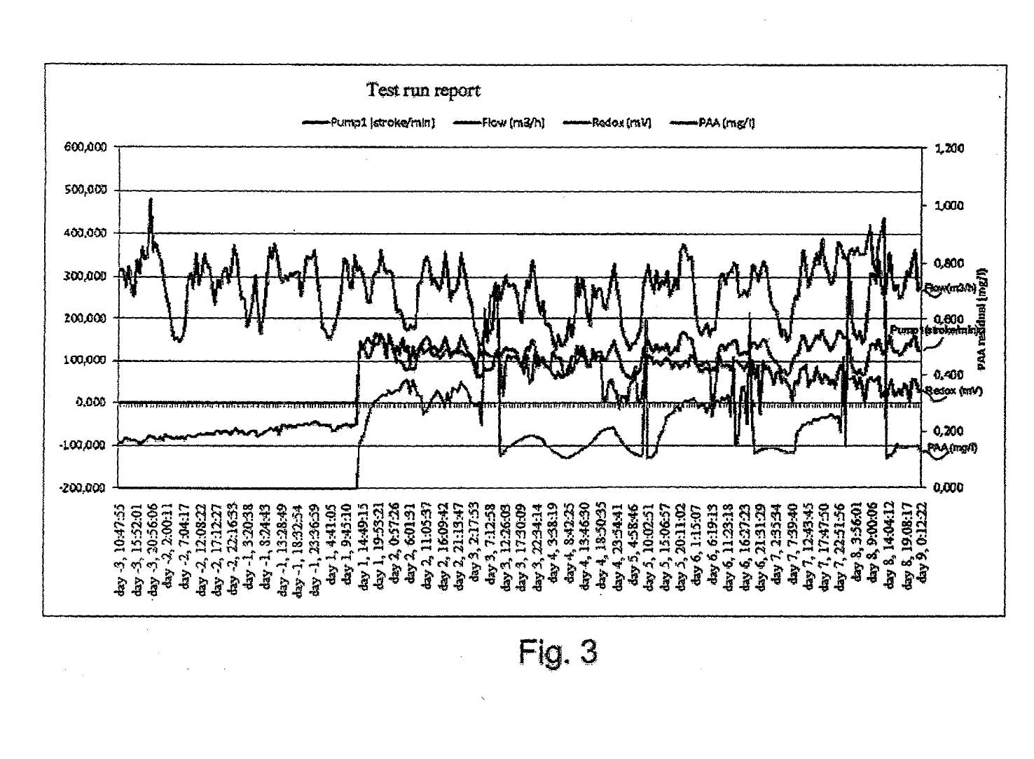

FIG. 3 compiles the data from the reporting period from day −3 to day 8 of the discharge flowing out from the wastewater purification plant, the stroke rate of the chemical feed pump, the redox potential and the residual PAA.

FIG. 3 shows that, with the basic setting of approximately 1.6 ppm of peracetic acid to the out-flow water, a rise of approximately 150 to 200 mV in the redox potential is achieved. The maximum capacity of the pump is 11.31/h, the pump stroke being 200 strokes/min, and the momentary PAA composition feed can also be calculated from the pump stroke rate.

The figure shows how the system operates. Since the redox sensor is located close to the feed point downstream, distinct variations are observable therein as the discharge radically changes. Within the study period, the variation of the outflow water discharge ranged between 130 and 480 m3/h. As the discharge of outflow water is reduced, the setting of the pump is lowered accordingly. The redox value temporarily decreases but is recovered back to the preset level as programmed. Correspondingly, as the discharge increases, the setting value of the pump is raised accordingly.

Right after the onset of the feed at day 1, a distinct rise in redox potential is visible in the graph. This clearly demonstrates that redox potential is the right way of measuring the need for peracetic acid. In addition, the graph shows how explicitly redox potential expresses the variations that occur in the water.

Since the PAA analyzer is installed at approximately 50 m +pump suction distance of 50 m down-stream, a peak in the residual PAA appears in connection with each decrease in the discharge. Correspondingly, as the discharge rapidly increases, a clear temporary reduction in the residual PAA is shown. This is because the analyzer analyzes water from such a distance that there is time for variation to occur in the discharge before the analyzer has analyzed the water. However, the figure shows that the program reacts well in time to the increasing residual PAA. Before each peak of the residual PAA, the graph clearly shows how the production of the pump is reduced.

The results clearly show that the quality of the purified water is excellent and that the method according to the invention is effective.

In addition, a Pilot test was conducted at the water purification plant concerning post-disinfection of the wastewater. The test measured fecal bacteria coli, which are the most important criterion of purity of water in terms of post-disinfection. The test was conducted in 52 days.

The plant being set in the normal state, 0-samples were taken on day 1 of the post-disinfection test. The addition of peracetic acid was then started according to the invention. Samples were taken approximately at intervals of one week. The addition of peracetic acid was stopped on day 35. After this, a reference sample for the 0-sample was taken (day 51). The results are presented in table 3.

TABLE 3

| | Sampling date | | | | |
|---|---|---|---|---|---|
| | Day 1 | Day 7 | Day 13 | Day 29 | Day 52 |
| Fecal | 4000 | 2 | 3 | 6 | 7200 |
| bacteria | | | | | |
| coli | | | | | |
| CFU/100 ml | | | | | |
| Notes | 0- | System on | System on | System on | Refererence |
| | sample | | | | sample |

The results clearly show that the quality of the purified water is excellent and that the method according to the invention is effective.

The invention is not limited merely to the examples of its embodiments referred to above; instead, many variations are possible within the scope of the inventive idea defined by the claims.

1. A method for continuous purification of wastewater, wherein peracetic acid is metered in wastewater, the flow of the wastewater and redox potential are measured, and the concentration of peracetic acid is measured downstream of the metering,
the metering of peracetic acid is adjusted directly relative to the variation of the flow and so as to have a concentration of peracetic acid of less than 0.8 ppm and a redox potential of 50 to 250 mV.

2. The method according to claim 1, wherein the metering of peracetic acid is adjusted so as to have a concentration of peracetic acid of less than 0.5 ppm and preferably of 0.05 to 0.2 ppm, and a redox potential of 80 to 120 mV and preferably of approximately 100 mV.

3. The method according to claim 1, wherein the concentration of peracetic acid is measured at 4 to 10 minutes, preferably at approximately 5 minutes, downstream of the metering.

4. The method according to claim 1, wherein the metering is performed after final sedimentation or right at the end thereof.

5. The method according to claim 1, wherein UV disinfection is performed after measuring the concentration.

6. The method according to claim 1, wherein the water is directed to a pipework for utility water.

7. A method for continuous purification of utility water, wherein peracetic acid is metered in raw water, the flow of the raw water and redox potential are measured, and the concentration of peracetic acid is measured downstream of the metering,
the metering of peracetic acid is adjusted directly relative to the flow and so as to have a concentration of peracetic acid of less than 0.8 ppm and a redox potential of 50 to 250 mV.

8. The method according to claim 7, wherein the metering of peracetic acid is adjusted so as to have a concentration of peracetic acid of less than 0.5 ppm and preferably of 0.05 to 0.2 ppm, and a redox potential of 80 to 120 mV and preferably of approximately 100 mV.

9. The method according to claim 7, wherein the concentration of peracetic acid is measured at 4 to 10 minutes, preferably at approximately 5 minutes, downstream of the metering.

10. The method according to claim 7, wherein the metering is performed after final sedimentation or right at the end thereof.

11. The method according to claim 7, wherein UV disinfection is performed after measuring the concentration.

12. The method according to claim 7, wherein chlorine or a derivative thereof is not added to the water until after the measuring of the concentration of peracetic acid or after the possible UV disinfection.

13. A system for purifying water, comprising
a peracetic acid metering device,
a flow meter for measuring the flow of the water,
a sensor for measuring the redox potential,
an analyzer for measuring the concentration of peracetic acid and
means for adjusting the metering device.
